(19) United States
(12) Patent Application Publication
(10) Pub. No.: US 2026/0302871 A1
(43) Pub. Date: Oct. 1, 2026

(54) HOUSING WITH A HOUSING COOLING DEVICE, ELECTRIC MACHINE, METHOD FOR COOLING THE ELECTRIC MACHINE, AND MOTOR VEHICLE

(71) Applicant: Schaeffler Technologies AG & Co. KG, Herzogenaurach (DE)

(72) Inventors: Christoph Heukenroth, Berlin (DE); Lennart Leopold, Berlin (DE); Wolfgang Halbmeyer, Berlin (DE); Ivan Krotow, Regensburg (DE); Martin Becker, Malsch (DE)

(73) Assignee: Schaeffler Technologies AG & Co. KG, Herzogenaurach (DE)

(21) Appl. No.: 18/992,177

(22) PCT Filed: Jul. 17, 2023
(86) PCT No.: PCT/EP2023/069759

§ 371 Date: Jan. 7, 2025

(30) Foreign Application Priority Data
Jul. 20, 2022 (DE) 10 2022 207 424.6

(51) Int. Cl. H02K 5/20; B60K 11/00; H02K 9/19

(52) U.S. Cl. CPC H02K 5/203; H02K 9/19; B60K 11/00

(57) ABSTRACT

A housing for an electric machine of an at least partially electrically driven motor vehicle having a cylindrical first housing part having an outer side, a tubular second housing part arranged on the first housing part and having an inner side, and a housing cooling device having a first coolant connection arranged in the second housing part, a second coolant connection arranged at a distance from the first coolant connection, and a cooling structure, which is intended to form a first cooling channel and a second cooling channel and is formed on the inner side and/or the outer side, wherein the first coolant connection and the second coolant connection are arranged offset from each other in the axial direction and in the circumferential direction of the second housing part, and the offset in the circumferential direction is greater than 135° and less than 225°, wherein the limits are inclusive, and the cooling structure has webs, which are formed in the radial direction of the first housing part and/or the second housing part, in order to form the cooling channels which, relative to the circumferential direction, are arranged offset from each other in the axial direction in a first portion, and run in the shape of a helix in a second portion,

### CROSS-REFERENCE TO RELATED APPLICATIONS

This application claims priority to PCT Application PCT/EP2023/069759, filed Jul. 17, 2023, which claims priority to German Patent Application No. DE 10 2022 207 424.6, filed Jul. 20, 2022. The disclosures of the above applications are incorporated herein by reference.

### FIELD OF THE INVENTION

The invention relates to a housing for an electric machine of an at least partially electrically driven motor vehicle, with two coolant connections, which are arranged offset from each other both in the axial direction and in the circumferential direction, and at least two cooling channels. The subject matter of the invention also includes an electric machine with the housing according to the invention. A further subject matter of the invention is a method for cooling the electric machine according to the invention. Another subject matter of the invention is a motor vehicle with the electric machine according to the invention.

### BACKGROUND OF THE INVENTION

A cooling means for electric machines is known in principle. For example, DE 10 2006 044 785 A1 shows a cooling means in which a stator is surrounded by a cooling base body, the outer side of which has a cooling structure with an inlet and a drain, wherein the cooling structure runs in the form of a helical trough or helically between the inlet and the drain. In other words, only one helical cooling channel is formed between the inlet and the drain. The disadvantage here is that it is not possible to achieve uniform cooling of the electric machine over the length of the cooling channel since the temperature of the cooling medium rises continuously with increasing distance from the inlet to the drain. This may be problematic if the active parts, i.e., the rotor and stator, of the electric machine are extended in the axial direction.

### SUMMARY OF THE INVENTION

One object of the invention is to specify a housing for an electric machine which has an increased cooling effect.

The object is achieved by the subject matter of the description which follows and the drawings. In this case, each feature may represent an aspect of the invention both individually and in combination, provided nothing to the contrary is explicitly stated in the description.

In a first aspect, the invention relates to a housing for an electric machine of an at least partially electrically driven motor vehicle having a first housing part having an outer side, a tubular second housing part arranged on the first housing part and having an inner side, and a housing cooling device having a first coolant connection arranged in the second housing part, a second coolant connection arranged at a distance from the first coolant connection, and a cooling structure, which is intended to form a first cooling channel and a second cooling channel and is formed on the inner side and/or the outer side, wherein the first coolant connection and the second coolant connection are arranged offset from each other in the axial direction and in the circumferential direction of the second housing part, and the offset in the circumferential direction is greater than 135° and less than 225°, the cooling structure has webs, which are formed in the radial direction of the first housing part and/or the second housing part and which, relative to the circumferential direction, are arranged offset from each other in the axial direction in a first portion, and run in the shape of a helix in a second portion.

In other words, according to the first aspect of the invention, a housing for an electric machine of an at least partially electrically driven motor vehicle is provided. The housing has a first housing part, which is, at least in portions, cylindrical. On a side directed outward in the radial direction, the first housing part has an outer side. A second housing part is also provided. The second housing part is tubular and has an inner side on a side facing the first housing part. The inner side of the second housing part therefore faces the outer side of the first housing part. The housing further includes a housing cooling device. In the second housing part, the housing cooling device has a first coolant connection and a second coolant connection arranged at a distance from the first coolant connection. The housing cooling device also includes a cooling structure formed on the inner side and/or the outer side, wherein the cooling structure is configured to form a first cooling channel and a second cooling channel. The first cooling channel and the second cooling channel therefore extend between the first coolant connection and the second coolant connection. The first coolant connection and the second coolant connection are located at a distance from each other in the axial direction of the second housing part and are also offset from each other in the circumferential direction of the second housing part. Starting from the first coolant connection, the second coolant connection is arranged offset at an angle of greater than 135° and less than 225°, in another embodiment is greater than 150° and less than 210°, and in another embodiment greater than 160° and less than 200°, wherein the limits are inclusive. The cooling structure also has webs, which are formed in the radial direction of the first housing part and/or the second housing part, in order to form the cooling channels. In a first portion, which relates to the circumferential direction of the first housing part and/or the second housing part, the cooling channels are arranged offset from or parallel to each other in the axial direction. In a second portion adjacent to the first portion, the first cooling channel and the second cooling channel run, at least in portions, in the shape of a helix.

If the webs are formed on the outer side of the first housing part, they seal the latter off from the inner side of the second housing part. However, it is also conceivable that the webs are formed on the inner side of the second housing part and seal the latter off from the outer side of the first housing part. Webs could also conceivably be formed both on the inner side of the second housing part and on the first side of the first housing part, these webs sealing off their respective components from each other. Due to the design of the at least two cooling channels, which extend between the coolant connections located at a distance from each other in the axial direction, the full length of the cooling channel is distributed over at least two shorter individual channels, which leads to lower pressure loss of a cooling medium flowing through the cooling channels. In addition, the temperature of the cooling medium flowing through the cooling channels rises more slowly due to the shorter length of an individual channel, which likewise has a positive effect on the cooling capacity. Furthermore, the special design of the webs, which are arranged offset or parallel to each other in the axial direction in a first portion, and run in the shape of a helix in a second portion, makes it possible to arrange the coolant connections to be offset from each other not only axially, but also in the circumferential direction. This has effect on the cooling capacity since the distance between an inlet and a drain is therefore increased.

A development of the invention is that, starting from the first coolant connection, the first cooling channel and the second cooling channel run in opposite directions. The opposite direction runs in the circumferential direction of the first and/or the second housing part. In other words, starting from the first coolant connection, the first cooling channel runs clockwise while the second cooling channel runs counterclockwise. Therefore, when the first coolant connection is formed as an inlet, the flow into the first cooling channel and the second cooling channel is uniform.

In an embodiment of the invention, it is provided that in a region of the second coolant connection, the first cooling channel and the second cooling channel converge at an angle of between 0° and 45°, wherein the limits are inclusive. The two cooling channels may therefore merge together and/or divide in a simple manner in the region of the second coolant connection. This may be, but is not limited to, the case in which the second coolant connection is formed as an outlet, and the first cooling channel and the second cooling channel are merged together in terms of flow in this region.

According to a development of the invention, it is provided that the first coolant connection is the inlet and the second coolant connection is the outlet. It may therefore be provided that a cooling medium enters the first cooling channel and the second cooling channel via the inlet, wherein this cooling medium then flows through the two cooling channels in opposite directions. The two cooling channels are then merged together in the region of the outlet, so that the cooling medium can be is discharged from the housing via the outlet or the second coolant connection.

An alternative embodiment of the invention provides that the first coolant connection is the outlet and the second coolant connection is the inlet. It is therefore conceivable that the inlet is formed in the region of the second coolant connection. A cooling medium flowing in via the second coolant connection is supplied to the first cooling channel and the second cooling channel, which, relative to the axial length of the housing, run parallel to each other in this region. In the region of the outlet, the cooling medium from the first cooling channel flows toward the cooling medium from the second cooling channel and is discharged from the housing via the outlet.

An embodiment of the invention is that the first cooling channel is redirected through 180° in a region. In other words, the flow direction of the first cooling channel is redirected in a region in such a way that, if starting from the first coolant connection, the flow direction of the first cooling channel is identical to the flow direction of the second cooling channel due to the redirection. By redirecting the first cooling channel and merging the first and second cooling channels in the region of the second coolant connection, it is possible to achieve cooling of the electric machine with only a first coolant connection and a second coolant connection. By reducing the number of coolant connections, leaks and costs are reduced.

It is conceivable that the first cooling channel and/or the second cooling channel have a plane and/or a flat contour between the webs.

Another development of the invention is that between the webs, the first cooling channel and/or the second cooling channel has, at least in portions, a groove-shaped contour which runs, at least in portions, parallel to the webs. The groove-shaped contour enables the surface area of the first cooling channel and/or the second cooling channel to be increased, thus making it possible to increase the cooling effect. The groove-shaped contour may be formed in a continuous, uninterrupted manner. However, it is also conceivable that the groove-shaped contour is only formed in portions. In this manner, turbulence is generated when the cooling medium flows through the first cooling channel and/or the second cooling channel. The turbulence causes the cooling medium within the first cooling channel and/or the second cooling channel to circulate, thus making it possible to increase the cooling effect.

In principle, it may be provided that a length of the first cooling channel differs from a length of the second cooling channel. In this case, however, the hydraulic resistance in the channels is to be adjusted in such a way that the flow through each individual channel is equal.

Alternatively, a development of the invention provides that a length of the first cooling channel corresponds substantially to a length of the second cooling channel. “Substantially” means that a length of the first cooling channel is at most +/−15% longer than a maximum length of the second cooling channel, in another embodiment is at most +/−10% longer than a maximum length of the second cooling channel, and in another embodiment at most +/−5% longer than a maximum length of the second cooling channel.

In this context, a development of the invention is that a cross section of the first cooling channel is identical to a cross section of the second cooling channel.

An embodiment of the invention provides that the first housing part is a cast component. The cast component is cast from a metal. The metal includes aluminum and/or is at least partially formed from aluminum. A housing of this type is inexpensive to produce, is lightweight and has increased thermal conductivity in order to transfer the heat absorbed by the housing from the active parts of the electric machine to the cooling medium.

According to an embodiment of the invention, it is provided that the second housing part is an extruded component. The extruded component is produced from a metal. A second component of this type is simple and inexpensive to produce, thus making it possible to reduce the costs of the housing.

In a second aspect, the invention relates to an electric machine having the housing according to the invention.

The electric machine may be formed as a separately excited and/or permanently excited electric machine.

The electric machine is a constituent part of a traction drive for an at least partially, or fully, electrically driven motor vehicle.

In a third aspect, the invention relates to a method for cooling the electric machine according to the invention, wherein a cooling medium is supplied to the first cooling channel and the second cooling channel via the first coolant connection or the second coolant connection, and is discharged from the housing via the other coolant connection.

In this manner, a method is provided, in which the electric machine has an increased cooling effect. An increased cooling effect of the electric machine also makes it possible to increase the efficiency or performance of the electric machine.

In principle, the cooling medium could conceivably be an oil. This is the case if the cooling medium comes into contact, at least partially, with the active parts of the electric machine. By using oil, corrosion of the active parts may be avoided.

It is conceivable that the cooling medium differs from oil. For example, the cooling medium may be water-based. The cooling medium could conceivably be a water-glycol mixture. A water-based cooling medium may be used if the cooling medium does not come into direct contact with transmission parts and/or the active parts of the electric machine.

In a fourth aspect, the invention relates to a motor vehicle with the electric machine according to the invention.

The electric machine is configured and/or formed to at least partially electrically drive the motor vehicle. For this purpose, it is provided that the electric machine is a constituent part of a traction drive of the motor vehicle.

It should be noted that all features described above and below with respect to one aspect of the present invention apply equally to any other aspect of the present invention. All features of the housing may also be features of the electric machine and/or features of the method and/or also features of the motor vehicle. This also applies conversely.

Further features of the present invention will emerge from the following exemplary embodiment. The exemplary embodiment is to be understood not as restrictive, but rather as an example. It is intended to enable a person skilled in the art to carry out the invention. The applicant reserves the right to make individual features and/or a plurality of the features disclosed in the exemplary embodiment. The exemplary embodiment is discussed in more detail on the basis of drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the drawings:

FIG. 1 shows a three-dimensional view of a housing for an electric machine;

FIG. 2 shows a longitudinal section through the housing of the electric machine;

FIG. 3 shows a detail view in the region of a cooling structure in a first embodiment;

FIG. 4 shows a detail view in the region of the cooling structure in a second embodiment;

FIG. 5 shows a three-dimensional view of an outer side of a first housing part of the housing from a first perspective; and

FIG. 6 shows a three-dimensional view of the cooling structure on the outer side from a second perspective.

### DETAILED DESCRIPTION OF THE PREFERRED EMBODIMENTS

The following description of the preferred embodiment(s) is merely exemplary in nature and is in no way intended to limit the invention, its application, or uses.

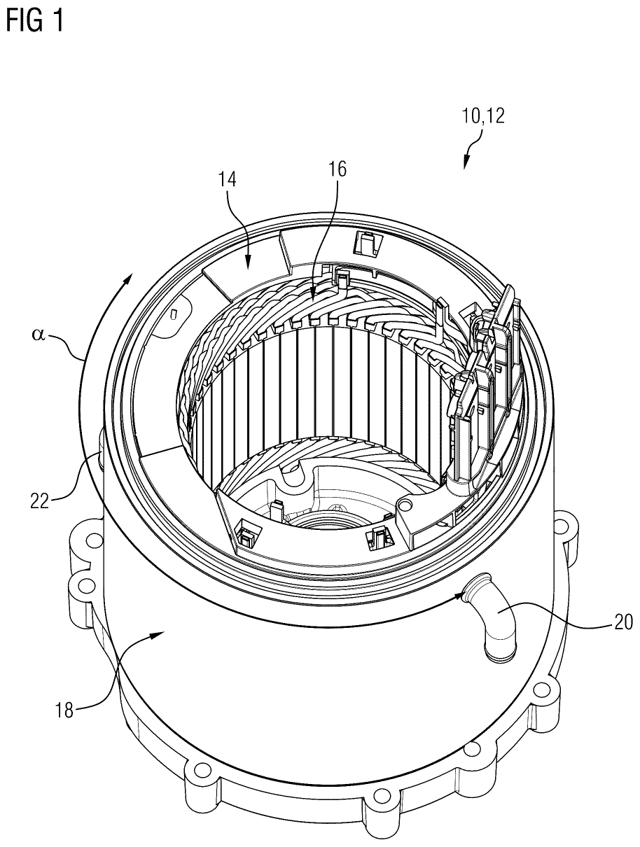

A three-dimensional view of a housing 10 for an electric machine 12 is shown in FIG. 1. The housing 10 has a first housing part 14, which is, at least in portions, cylindrical. A stator 16 of the electric machine 12 is non-rotatably arranged within the first housing part 14. A second housing part 18 is arranged on the cylindrical portion of the first housing part 14. The housing 10 further has a housing cooling device. The housing cooling device has a first coolant connection 20 in the second housing part 18 and a second coolant connection 22 arranged at a distance from the first coolant connection 20.

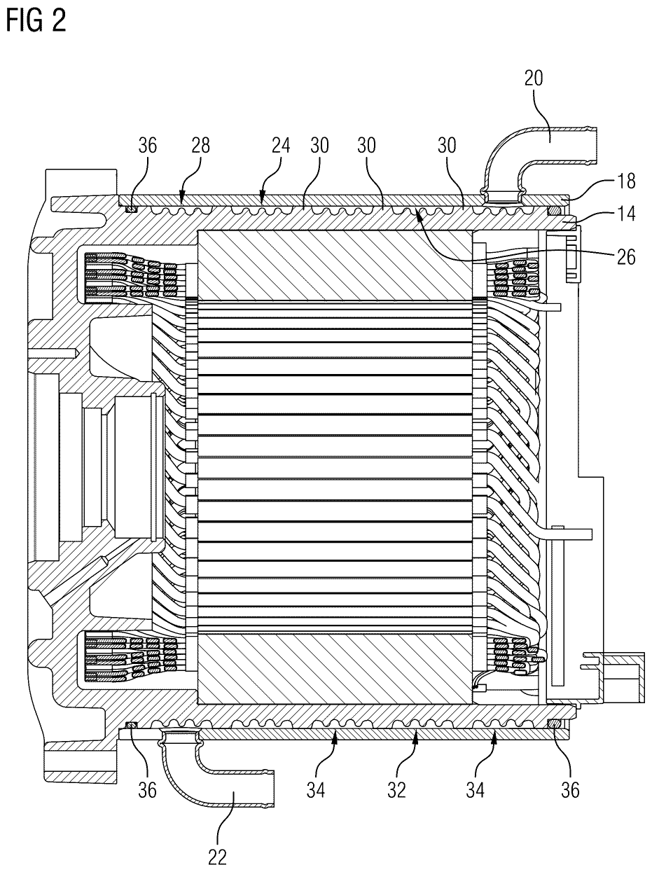

FIG. 2 shows a longitudinal section through the housing 10, known from FIG. 1, of the electric machine 12. On a side directed outward in the radial direction, the first housing part 14 has an outer side 24. In addition, on a side directed inward in the radial direction, the second housing part 18 has an inner side 26. The inner side 26 of the second housing part 18 faces the outer side 24 of the first housing part 14. In addition to the first coolant connection 20 and the second coolant connection 22, the housing cooling device includes a cooling structure 28 formed on the outer side 24. The cooling structure 28 forms a first cooling channel 32 and a second cooling channel 34, which are separated from each other via webs 30. The first cooling channel 32 and the second cooling channel 34 extend between the first coolant connection 20 and the second coolant connection 22. The webs 30 are formed on the outer side 24 and seal the latter off in a fluid-tight manner from the inner side 26 of the second housing part 18.

The first coolant connection 20 and the second coolant connection 22 are located at a distance from each other in the axial direction of the second housing part 18 and are also offset from each other in the circumferential direction of the second housing part 18. Starting from the first coolant connection 20, the second coolant connection 22 is arranged offset from the first coolant connection 20 at an angle a of 170° in the circumferential direction.

At a respective axial end of the second housing part 18, the second housing part 18 is sealed off from the first housing part 14 in a fluid-tight and/or medium-tight manner via a sealing element 36, such as via O-rings.

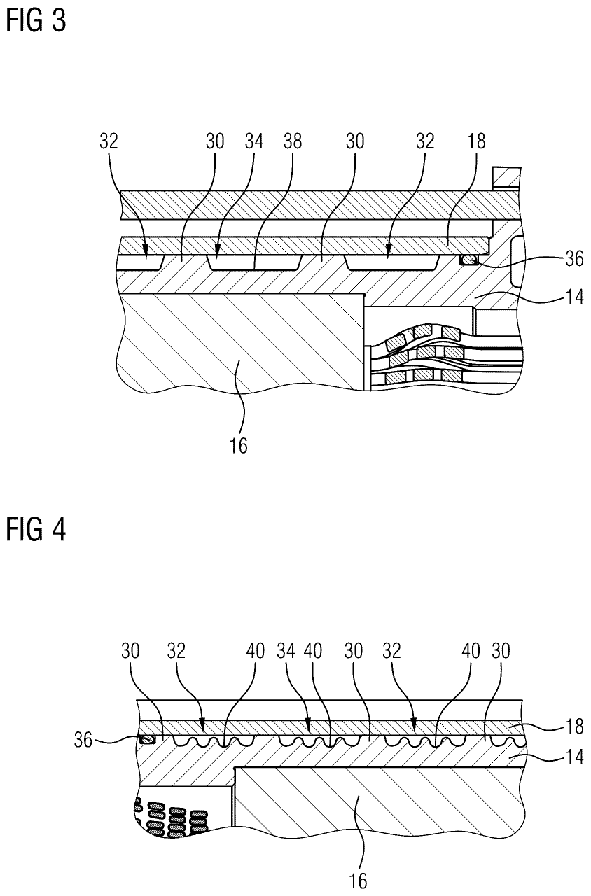

FIG. 3 shows a detail view in the region of the cooling structure 28 in a first embodiment. Between the webs 30, the first cooling channel 32 and the second cooling channel 34 have a planar surface 38, which runs parallel to the longitudinal axis of the housing 10. A configuration of this type with respect to the flat surface 38 may be provided either over the full length of the first cooling channel 32 and/or over the full length of the second cooling channel 34. It is also conceivable that the planar surface 38 is only formed locally, such as in a region of the first coolant connection 20 and/or the second coolant connection 22.

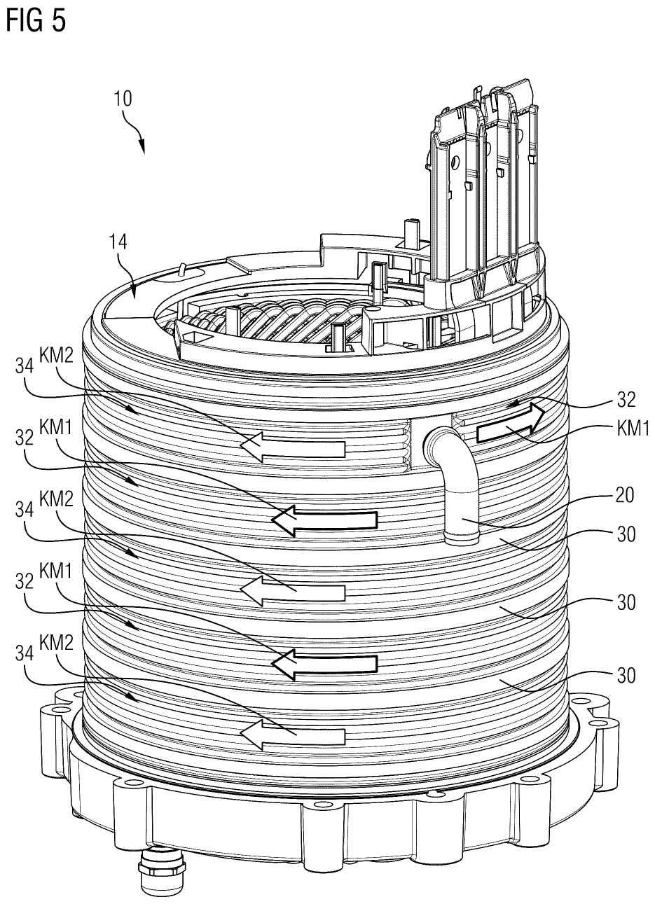

FIG. 4 shows a detail view in the region of the cooling structure 28 in a second embodiment. In the second embodiment, the first cooling channel 32 and the second cooling channel 34 have at least one groove-shaped contour 40 between the webs 30, this groove-shaped contour running, at least in portions, parallel to the webs 30. The groove-shaped contour 40 increases the surface area of the first cooling channel 32 and of the second cooling channel 34, thus making it possible to increase the cooling effect. The groove-shaped contour may be formed in a continuous, uninterrupted manner. However, it is also conceivable that the groove-shaped contour 40 is only formed in portions. In this manner, turbulence is generated when a cooling medium flows through the first cooling channel 32 and/or the second cooling channel 34. The turbulence causes the cooling medium within the first cooling channel 32 and/or the second cooling channel 34 to circulate, thus making it possible to increase the cooling effect.

FIG. 5 shows a three-dimensional view of the outer side 24 of the first housing part 14 from a first perspective. The first coolant connection 20 is shown from the first perspective. In the present exemplary embodiment, the first coolant connection 20 is formed as an inlet. In other words, a cooling medium for cooling the housing 10 is supplied to the cooling structure 28 via the inlet.

As shown from the first perspective, the webs 30 for forming the first cooling channel 32 and the second cooling channel 34 are arranged parallel to each another over a first portion 42, which extends in the circumferential direction of the housing 10, relative to the longitudinal direction of the housing 10.

A cooling medium, which is supplied to the cooling structure 28 via the first coolant connection 20, flows into the first cooling channel 32 and the second cooling channel 34, which, starting from the first coolant connection 20, run in opposite directions in the circumferential direction of the housing 10.

The portion of the cooling medium flowing into the first cooling channel 32 is represented as KM1. The portion of the cooling medium flowing into the second cooling channel 34 is represented as KM2.

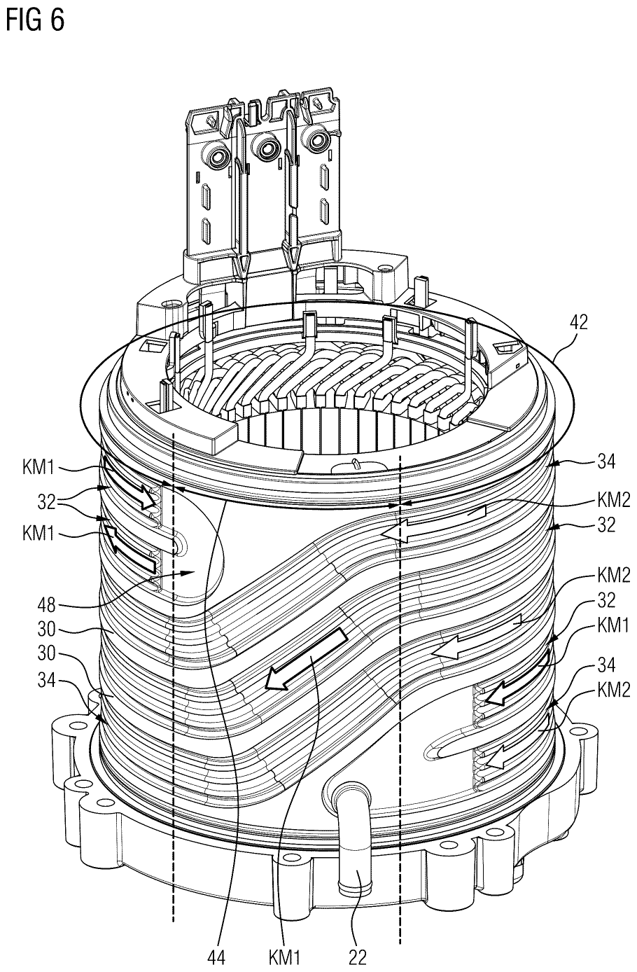

FIG. 6 shows a three-dimensional view of the cooling structure 28 on the outer side 24 of the second housing part 18 from a second perspective. The second coolant connection 22, via which the cooling medium is discharged from the housing 10, is shown from the second perspective.

Also shown is a second portion 44, which is adjacent to the first portion 42 and in which the first cooling channel 32 and the second cooling channel 34 run in the shape of a helix. The figure also shows that the first cooling channel 32 is redirected through 180° in a region 48. In other words, the flow direction of the first cooling channel 32 is redirected in a region 48 in such a way that, due to the redirection, the flow direction of the first cooling channel 32 is identical to the flow direction of the second cooling channel 34. By redirecting the second cooling channel 34 and merging the first cooling channel 32 and the second cooling channel 34 in the region of the second coolant connection 22, it is possible, in the case of two cooling channels, to achieve cooling of the electric machine 12 with only a first coolant connection 20 and a second coolant connection 22. By reducing the number of coolant connections 20, 22 for the two cooling channels 32, 34, leaks and costs are reduced.

Due to the design of the at least two cooling channels 32, 34, which extend between the coolant connections 20, 22 located at a distance from each other in the axial direction, the full length of the cooling channel is distributed over at least two shorter individual channels, which leads to lower pressure loss of a cooling medium flowing through the cooling channels 32, 34. In addition, the temperature of the cooling medium flowing through the cooling channels 32, 34 rises more slowly due to the shorter length of an individual channel, which may likewise have a positive effect on the cooling capacity. Furthermore, the special design of the webs 30, which are arranged offset from each other in the axial direction in the first portion 42, and run in the shape of a helix in the second portion 44, makes it possible to arrange the coolant connections 20, 22 to be offset from each other not only axially, but also in the circumferential direction. This has an effect on the cooling capacity since the distance between an inlet and a drain can therefore be increased.

The description of the invention is merely exemplary in nature and, thus, variations that do not depart from the gist of the invention are intended to be within the scope of the invention. Such variations are not to be regarded as a departure from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A housing for an electric machine of an at least partially electrically driven motor vehicle comprising:
a cylindrical first housing part having an outer side;
a tubular second housing part arranged on the cylindrical first housing part and having an inner side;
a housing cooling device, further comprising:
a first coolant connection arranged in the tubular second housing part;
a second coolant connection arranged at a distance from the first coolant connection;
a cooling structure formed on the inner side and/or the outer side, the cooling structure further comprising:
a first cooling channel;
a second cooling channel; and
a plurality of webs, each of which is formed in the radial direction of one of the cylindrical first housing part and/or the tubular second housing part, each of the plurality of webs being part of one of the first cooling channel or the second cooling channel;
wherein the first coolant connection and the second coolant connection are arranged offset from each other in the axial direction and in the circumferential direction of the tubular second housing part; and
wherein each of the plurality of webs, relative to the circumferential direction, are arranged offset from and/or parallel to each other in the axial direction in a first portion, and run in the shape of a helix in a second portion.

15. The housing of claim 1, wherein the offset of the first coolant connection and the second coolant connection in the circumferential direction is greater than 135° and less than 225°, wherein the limits are inclusive.

16. The housing of claim 1, wherein starting from the first coolant connection, the first cooling channel and the second cooling channel run in opposite directions.

17. The housing of claim 1, wherein, in a region of the second coolant connection, the first cooling channel and the second cooling channel converge at an angle.

18. The housing of claim 4, wherein the angle is between 0° and 45°, wherein the limits are inclusive.

19. The housing of claim 1, wherein the first coolant connection is the inlet and the second coolant connection is the outlet.

20. The housing of claim 1, wherein the first coolant connection is the outlet and the second coolant connection is the inlet.

21. The housing of claim 1, wherein first cooling channel is redirected through 180° in a region.

22. The housing of claim 1, the first cooling channel and/or the second cooling channel further comprising:
a groove-shaped contour between the webs;
wherein the groove-shaped contour is, at least in portions, parallel to the webs.

23. The housing of claim 1, wherein a length of the first cooling channel corresponds substantially to a length of the second cooling channel.

24. The housing of claim 1, wherein the cylindrical first housing part is a cast component.

25. The housing of claim 1, wherein the tubular second housing part is an extruded component.

26. An electric machine with a housing of claim 1.

27. A method for cooling an electric machine of claim 11, comprising the steps of:
supplying a cooling medium to the first cooling channel and the second cooling channel via the first coolant connection or the second coolant connection;
discharging the cooling medium from the housing via the other coolant connection.

28. A motor vehicle with an electric machine of claim 11.
